(19) United States
(12) Patent Application Publication
(10) Pub. No.: US 2008/0231022 A1
(43) Pub. Date: Sep. 25, 2008

(54) Stroller

(76) Inventors: Yan-Ge Hu, Taipei (TW); Zhi-Ren Zhong, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/050,958

(22) Filed: Mar. 19, 2008

Related U.S. Application Data
(60) Provisional application No. 60/895,482, filed on Mar. 19, 2007.

(51) Int. Cl. B62B 7/12

(52) U.S. Cl. 280/643

(57) ABSTRACT

The coupling device for a carrier (a bassinet or a child seat) is configured at the outer side of the stroller frame so that the carrier can be as wide as possible for child inside to have a roomy environment. Additionally, a connection device is further configured between the coupling device and the stroller frame for bringing the carrier to rotate with the stroller frame and keeping or adjusting the tilt angle of the carrier mounted on the stroller when the stroller frame is folding.

### CROSS REFERENCE TO RELATED APPLICATIONS

This application claims the benefit of U.S. Provisional Applications No. 60/895,482, which was filed on Mar. 19, 2007 and is incorporated herein by reference.

### BACKGROUND OF THE INVENTION

1. Field of the Invention

The present invention relates to a stroller, more particularly to a stroller having coupling devices configured at the outer side of the stroller frame for larger carrier room.

2. Description of the Prior Art

Please refer to FIG. 1 and FIG. 2. FIG. 1 is an illustration of a stroller frame 1 according to the prior art and FIG. 2 is an illustration of a bassinet 2. The bassinet 2 in the prior art is positioned on the stroller frame 1 by use of coupling devices 7, as FIG. 1 shows. The coupling devices 7 are configured at the inner sides of the stroller frame 1, thus it leads the distance W2 between the coupling devices 7 smaller than the overall width W3 of the stroller frame 1. Therefore, the width W1 of the bassinet 2 would be smaller than the distance W2 between the coupling devices 7 for the bassinet 2 to successfully couple to the stroller frame 1. From the above, the bassinet 2 is somehow smaller in size and apparently not good enough to provide roomy environment for a child inside.

Secondly, the prior art also reveals that the bassinet 2, or a car seat in other condition, mounted on the stroller frame 2 must be removed from the stroller frame 2 before the stroller frame 2 folds, which also causes inconvenience to the user. Additionally, the overall folded size of the stroller frame 2 and the seat part (like the bassinet 2 or the car seat) stacking up is too big for carrying.

### SUMMARY OF THE INVENTION

The present invention provides a stroller. The stroller comprises a stroller frame capable of being selectively set in a folded state, a coupling device mounted at the outer side of the stroller frame, a receiving frame having an insertion piece for coupling to the coupling device to detachably configured on the stroller frame, and a linkage device connecting between the coupling device and the stroller frame for driving the coupling device to cooperate with the receiving frame when the stroller frame is set in the folded state.

The present invention also provides a stroller. The stroller comprises a stroller frame, a coupling device mounted at the outer side of the stroller frame, and a carrier having an insertion piece for detachably coupling the carrier to the coupling device of the stroller frame.

The present invention also provides a stroller frame for detachably coupling a carrier. The stroller frame comprises two side frames and two first coupling devices mounted at the outer sides of the respective side frame of the stroller frame and configured to detachably couple to two second coupling devices on the carrier respectively. The distance between the two side frames is smaller than the distance between the two first coupling devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a stroller according to the prior art.

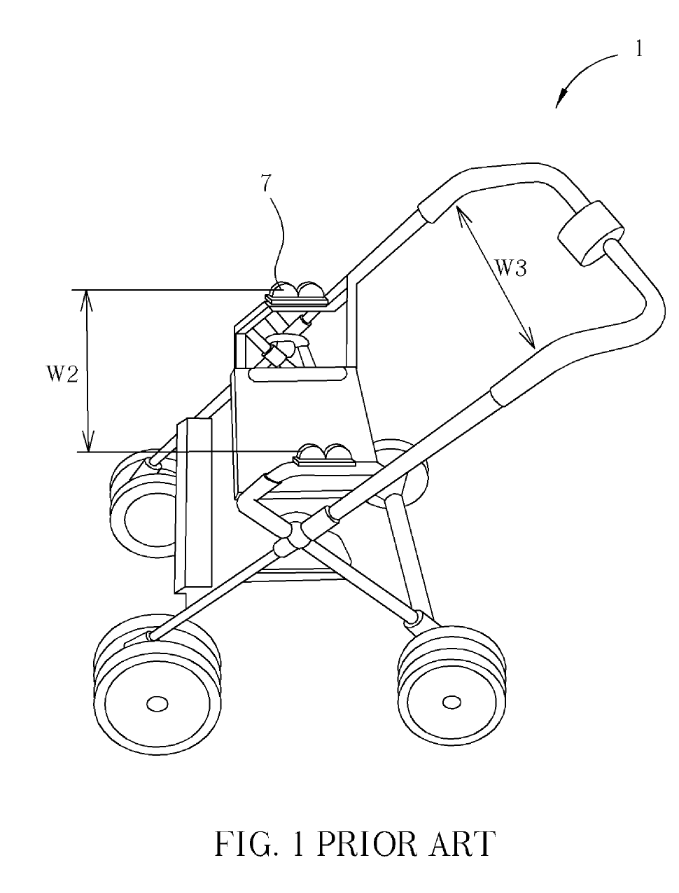

FIG. 2 is an illustration of a bassinet according to the prior art.

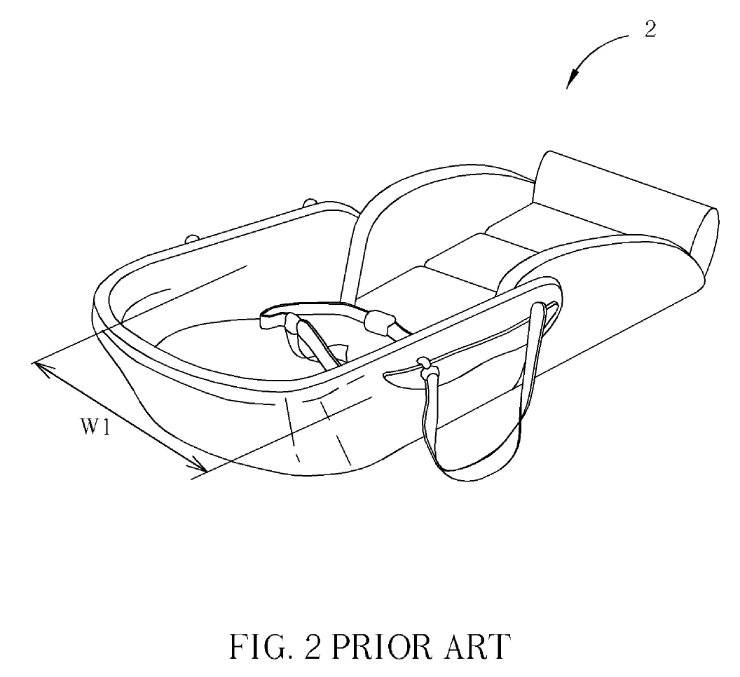

FIG. 3 is an illustration of a first embodiment according to the present invention.

FIG. 4 is an illustration of the enlarged view of the area A in FIG. 3.

FIG. 5 is an illustration of the top view of FIG. 3.

FIG. 6 is an illustration of a second embodiment of the present invention when the bassinet is set in the seating state.

FIG. 7 is an illustration of the side view of the second embodiment when the bassinet is set in the lying state.

FIG. 8 is an illustration of the enlarged view of the area B in FIG. 6.

FIG. 9 is an illustration of the embodiment in FIG. 6 in the folded state.

FIG. 10 is an illustration of a third embodiment coupling with a seat according to the present invention.

FIG. 11 is an illustration of a fourth embodiment coupling with a car seat according to the present invention.

### DETAILED DESCRIPTION

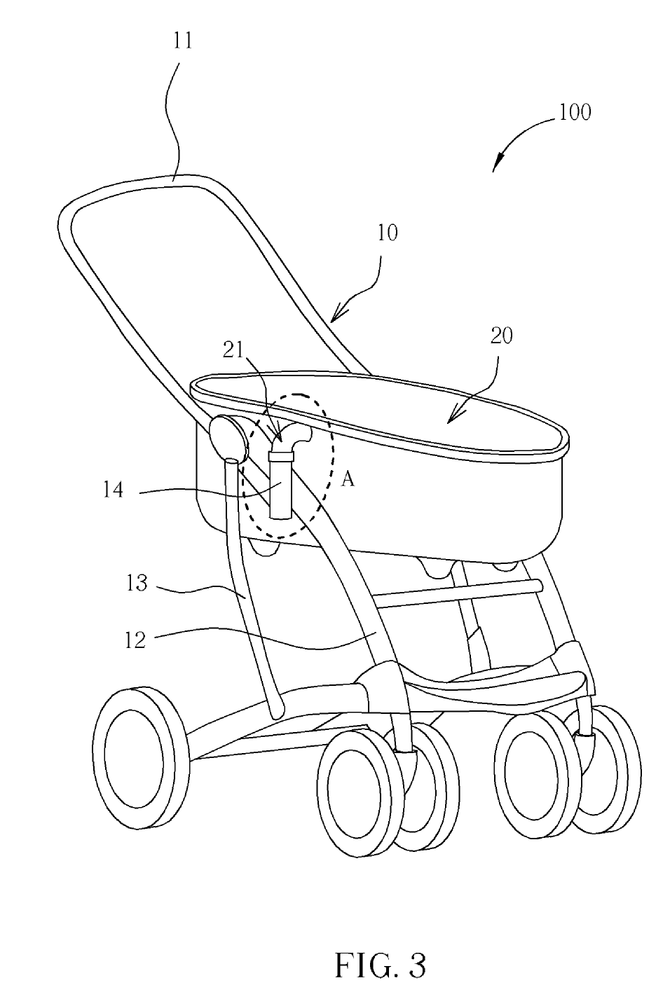

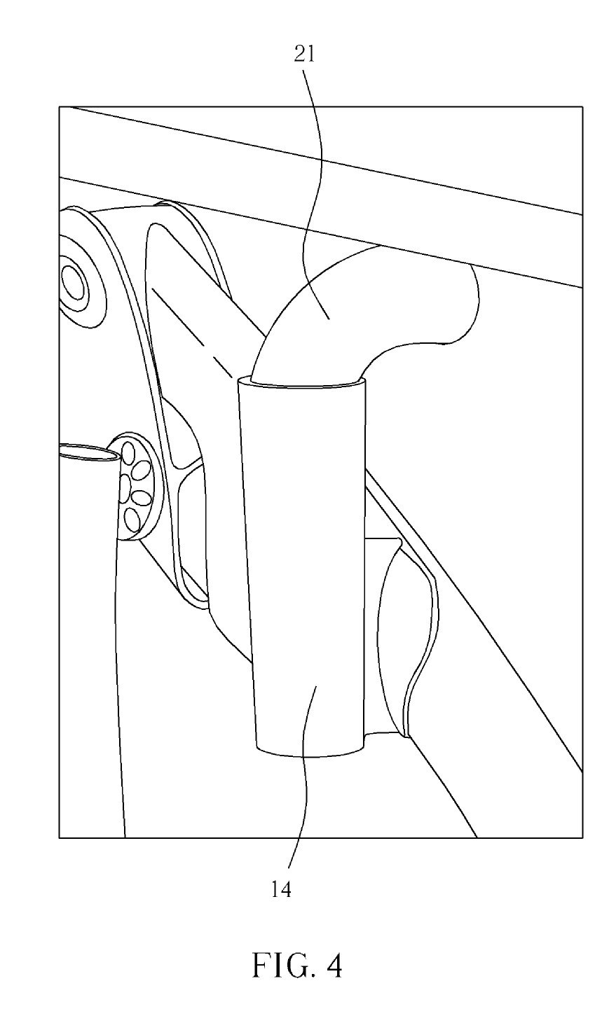

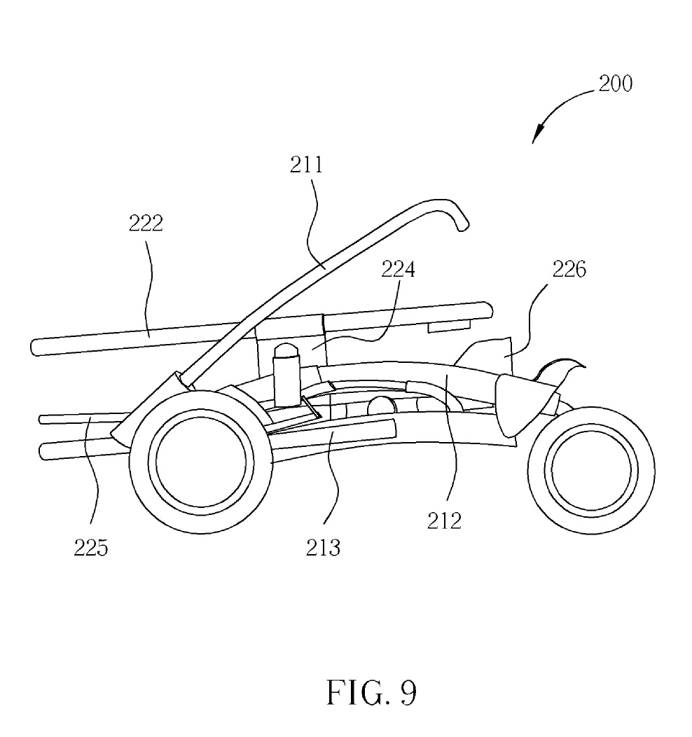

Please refer to FIG. 3 and FIG. 4. FIG. 3 is an illustration of a first embodiment according to the present invention and FIG. 4 is an illustration of the enlarged view of the area A in FIG. 3. The stroller 100 in FIG. 3 comprises a stroller frame 10, a coupling device 14, and a bassinet 20. The stroller frame 10 comprises a handle 11, a front leg frame 12, and a rear leg frame 13. The handle 11, the front leg frame 12, and the rear leg frame 13 pivot to one another so that the stroller 100 can be set in an opened state as in FIG. 3 or a folded state (similar as another embodiment in FIG. 9). The coupling device 14 is mounted at the outer side of the front leg frame 12 that can be realized as a monolithic part of the front leg frame 12 or a separate component detachably connecting to the front leg frame 12 and rotatable with the front leg frame 12. The bassinet 20 has an insertion piece 21 as either a part extending from the bassinet 20 or a single component detachably connecting to the bassinet 20. When the insertion piece 21 of the bassinet 20 inserts into the coupling device 14 for engagement, the bassinet 20 is positioned assembled on the stroller frame 10 in a detachable way.

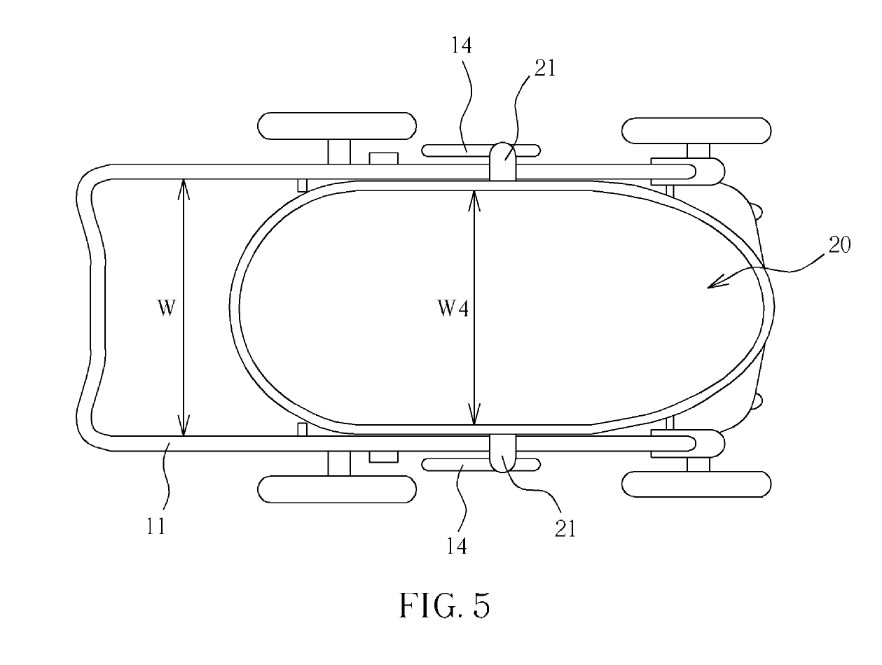

Please refer to FIG. 5. FIG. 5 is an illustration of the top view of the stroller 100 in FIG. 3. Because the coupling devices 14 are mounted at the opposite outer sides of the front leg frame 12 of the stroller frame 10, the width W4 of the bassinet 20 is not restricted by the distance between the two coupling devices 14 at the opposite outer sides of the front leg frame 12 and can stretch as long as close to the width W of the stroller frame 10. The baby or child (not shown in the figure) sitting/lying inside the bassinet 20 can therefore have spacious room and feel better. Additionally, the bassinet 20 in the embodiment can also be mounted on the stroller frame 10 either facing forward (the right direction in FIG. 5) or facing backward (the left direction in FIG. 5).

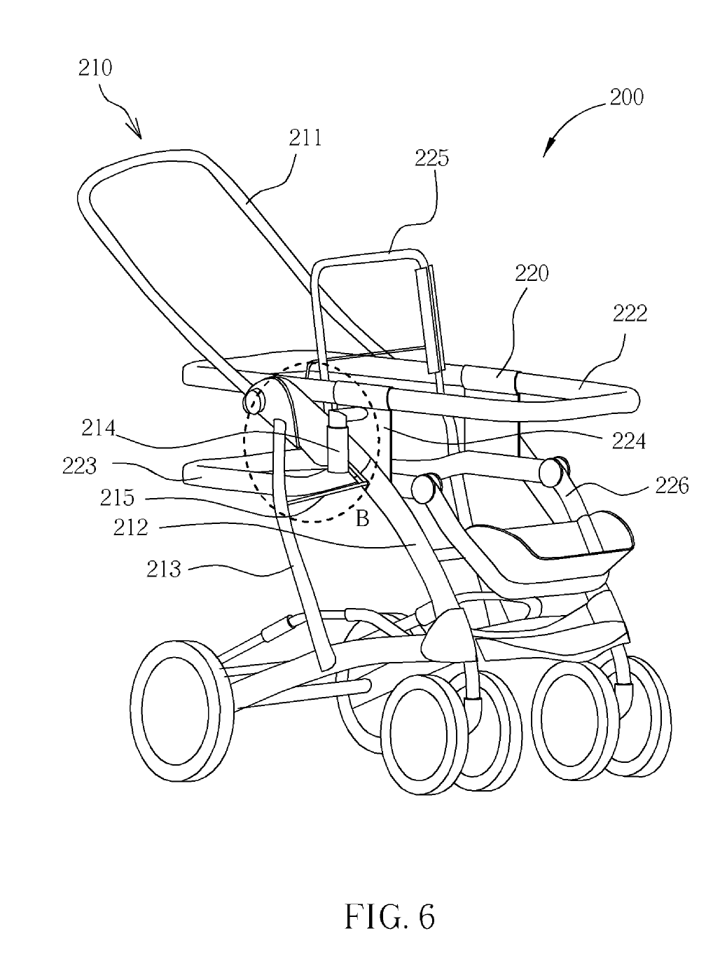

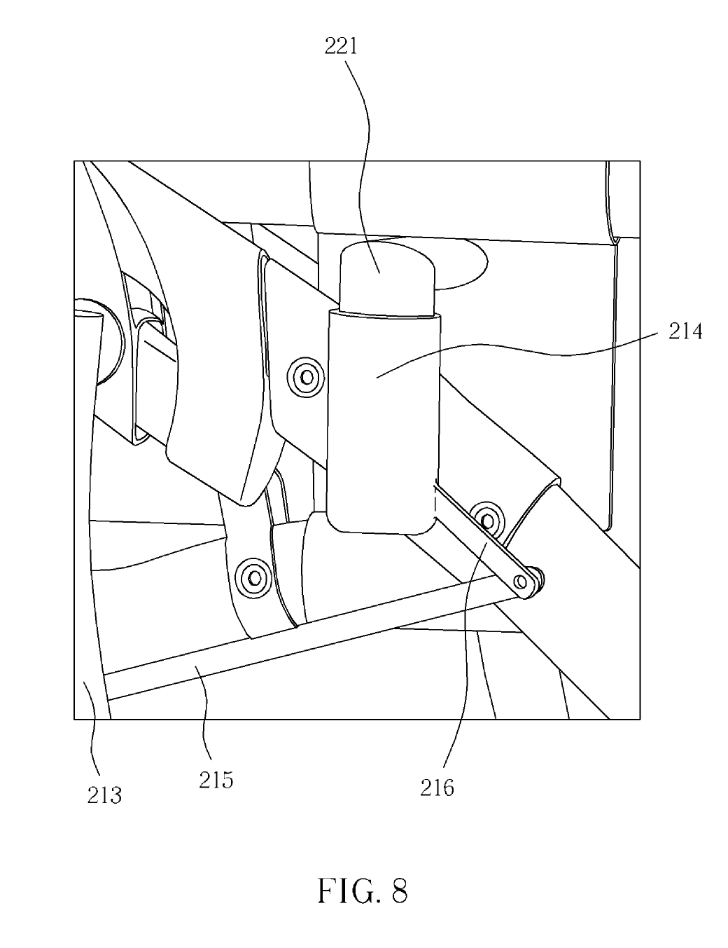

Please refer to FIG. 6. FIG. 6 is an illustration of a preferred exemplary embodiment of the stroller according to the present invention. The stroller 200 in FIG. 6 is set in the opened state and the bassinet 220 is in a seating state. FIG. 8 shows an illustration of the enlarged view of area B of the stroller 200 in FIG. 6. The stroller 200 comprises a stroller frame 210, a coupling device 214, a bassinet 220, and a linkage device comprising a first link 215 and a second link 216. The stroller frame 210 comprises a handle 211, a front leg frame 212, and a rear leg frame 213, each of the components of the stroller frame 210 pivoting to one another so that the stroller 200 can be set in the opened state as in FIG. 6 or a folded stated as in FIG. 9. The coupling device 214 is mounted at the outer side of the front leg frame 212 of the stroller frame 210 that can be realized as a monolithic part of the front leg frame 212 or a separate component detachably connecting to the front leg frame 212 and rotatable with the front leg frame 212. Please refer to FIG. 8. The coupling device 214 further connects to the rear leg frame 213 via the linkage device. The first link 215 of the linkage device pivots to the rear leg frame 213 and the second link 216. The second link 216 pivots to first link 215 and connects to the coupling device 214. When the stroller frame 210 folds from the opened state in FIG. 6 to the folded state in FIG. 9, the rear leg frame 213 pivots downward and brings the first link 215 to move along and pivot. Meanwhile, the first link 215 pulls the second link 216 to cause the coupling device 214 to rotate relative to the front leg frame 212. The bassinet 220 mounted on the stroller 200 rotates with the coupling device 214 as well and lowers down with the folding process of the stroller 200. In FIG. 9, the lowered bassinet 220 still lies within the stroller frame 210 with each of the components of the stroller 200 (including the front leg frame 212 and the rear leg frame 213 of the stroller frame 210, and the bassinet 220) posing to one another in a substantially parallel way. The overall folded size of the stroller 200 is much smaller than the size of the stroller frame 210 and the bassinet 220 stacking up and is easy for carrying.

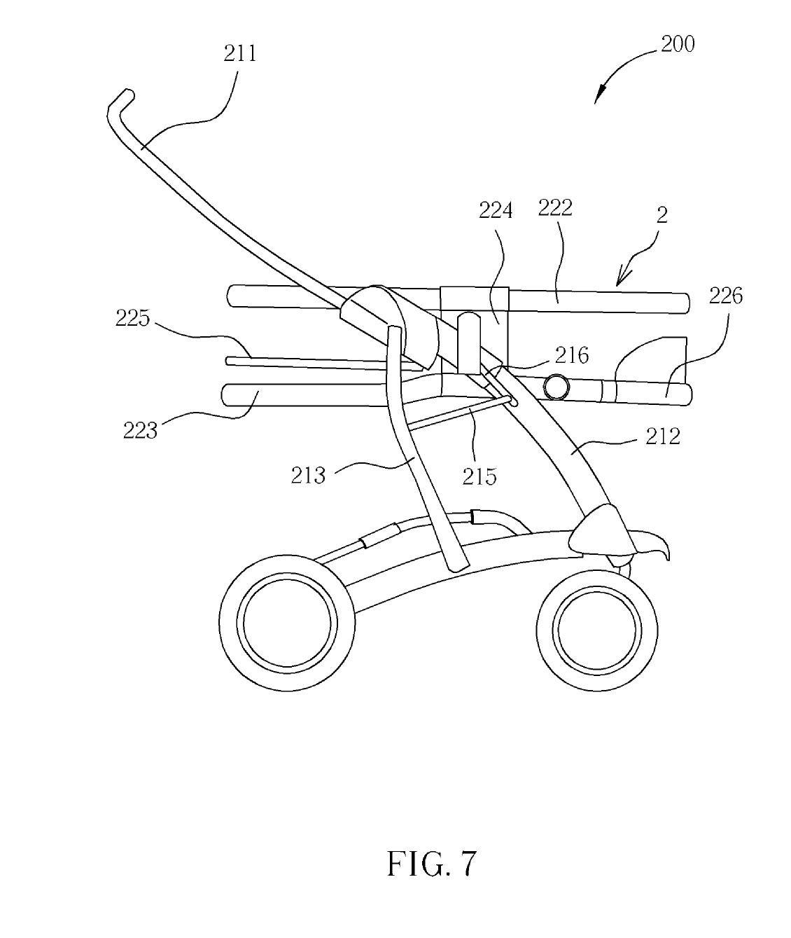

In FIG. 6, the bassinet 220 is comprised by a receiving frame (top frame 222) and a bassinet frame (bottom frame 223), with a connection piece 224 connecting between the top frame 222 and the bottom frame 223. An insertion piece 221 is further configured on the connection piece 224 for coupling to the coupling device 214. The bassinet 220 can then be positioned and assembled on the stroller frame 210 in a detachable way. The bassinet 220 further comprises a backrest frame 225 and a legrest frame 226 connecting to the bottom frame 223 respectively and can pivot on the bottom frame 223 separately. The backrest frame 225 or the legrest frame 226 can be adjusted individually either to the state as in FIG. 6, which in such state the bassinet 220 is served to be a seat, or to the state as in FIG. 7, which in such state the bassinet 220 is served as what it is called for.

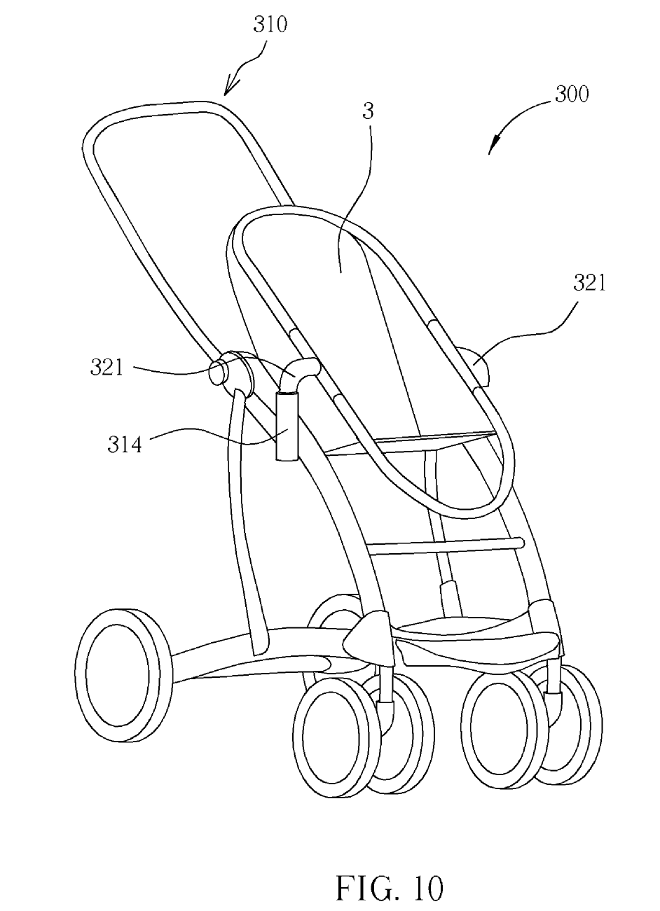

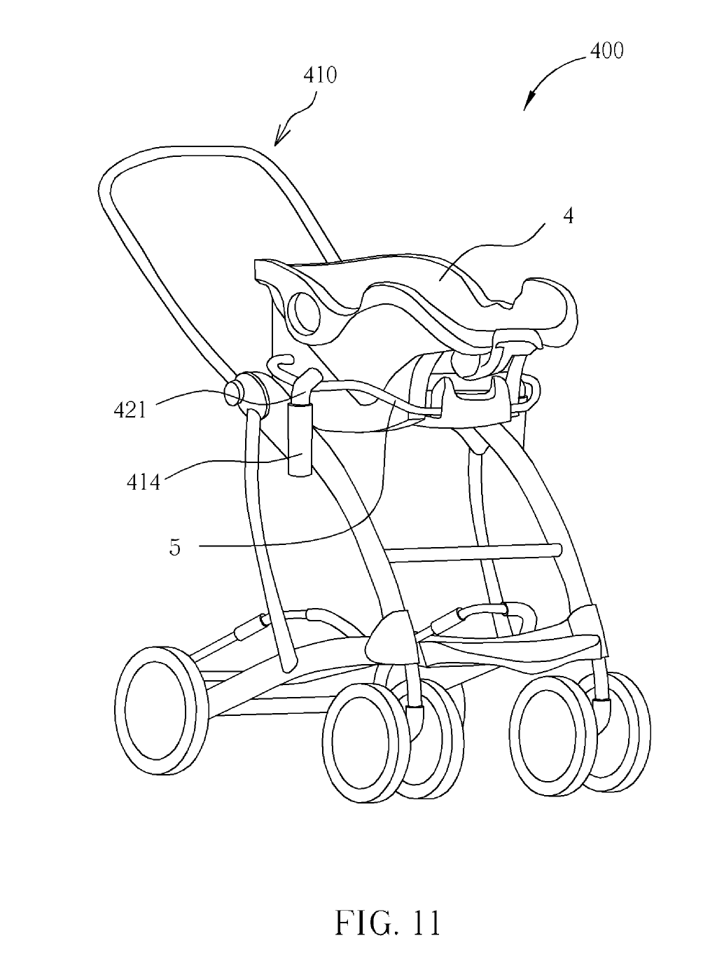

Please refer to FIG. 10 and FIG. 11 for more preferred exemplary embodiments in the present invention. The strollers 300, 400 disclosed in the present invention comprise a seat 3 in FIG. 10 or a car seat 4 in FIG. 11. When the seat 3 couples to the stroller frame 310 or the car seat 4 couples to the stroller frame 410, the coupling devices 314, 414 at the outer sides of the stroller frame make the stroller frame 310 or 410 foldable without removing the seat 3 or the car seat 4 in advance.

Also in the embodiment in FIG. 11, the car seat 4 is mounted on the stroller frame 410 via a receiving frame 5 having an insertion piece 421. The insertion piece 421 of the receiving frame 5 couples to the coupling device 414 of the stroller frame 410 first, and then the car seat 4 is assembled with the receiving frame 5. In the embodiment in FIG. 10, the seat 3 has two insertion pieces 321 at both sides for coupling to the coupling devices 314 of the stroller frame 310. Each coupling form of the embodiments disclosed aforementioned can be applied alternatively on different embodiment and the description of each embodiment should not be taken as limitation of the scope of the present invention.

The present invention utilizes the coupling devices for a carrier (a bassinet or a child seat) that are mounted at the outer sides of the stroller frame so that the carrier can be as wide as possible for child inside to have a roomy environment. Besides, mounting the carrier on the stroller frame or detaching the carrier from the stroller frame therefore will not disturb the baby seated inside. It is also much easier for the operation of mounting the carrier or detaching the carrier. Additionally, a connection device is further configured between the coupling device and the stroller frame for bringing the carrier to rotate with the stroller frame and keeping or adjusting the tilt angle of the carrier mounted on the stroller when the stroller frame is folding.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stroller, comprising:
a stroller frame capable of being selectively set in a folded state;
a coupling device mounted at the outer side of the stroller frame;
a receiving frame having an insertion piece for coupling to the coupling device to detachably configured on the stroller frame; and
a linkage device connecting between the coupling device and the stroller frame for driving the coupling device to cooperate with the receiving frame when the stroller frame is set in the folded state.

2. The stroller of claim 1, wherein the receiving frame is utilized for receiving a bassinet or a child seat.

3. The stroller of claim 1, wherein the receiving frame comprises a bassinet or a child seat.

4. The stroller of claim 3, further comprising a bassinet frame, the receiving frame receiving the bassinet frame via a connection piece.

5. The stroller of claim 4, wherein the bassinet frame comprises a first frame, a second frame, and a third frame, the first frame connecting to the receiving frame via the connection piece, the second frame and the third frame pivoting to the first frame and capable of being set in a first position or a second position respectively.

6. The stroller of claim 1, wherein the stroller frame comprises a front leg frame and a rear leg frame, the coupling device mounted at the outer side of the front leg frame, the linkage device connecting to the coupling device and the rear leg frame, and the front leg frame, the rear leg, and the receiving frame being substantially parallel to one another when the stroller frame is set in the folded state.

7. The stroller of claim 1, wherein the linkage device comprises a first link and a second link, one end of the second link connecting to the coupling device and the first link pivoting to the stroller frame and the other end of the second link.

8. A stroller, comprising:
a stroller frame;
a coupling device mounted at the outer side of the stroller frame; and
a carrier having an insertion piece for detachably coupling the carrier to the coupling device of the stroller frame.

9. The stroller of claim 8, wherein the stroller frame comprises a front leg frame and a rear leg frame, the coupling device mounted at the outer side of the front leg frame.

10. The stroller of claim 8, wherein the stroller frame is capable of being selectively set in a folded state, and the stroller further comprises a linkage device connecting between the coupling device and the stroller frame for driving the coupling device to cooperate with the carrier when the stroller frame is set in the folded state.

11. The stroller of claim 10, wherein the linkage device comprises a first link and a second link, one end of the second link connecting to the coupling device and the first link pivoting to the stroller frame and the other end of the second link.

12. The stroller of claim 8, wherein the carrier is a bassinet or a child seat.

13. The stroller of claim 12, wherein the carrier comprises a top frame, a bottom frame, a connection piece, a legrest frame, and a backrest frame, the insertion piece mounted on the connection piece, the top frame connecting to the bottom frame via the connection piece, the legrest frame pivoting to the bottom frame and capable of being set in a first position or a second position, and the backrest frame pivoting to the bottom frame and capable of being set in a first position or a second position.

14. The stroller of claim 8, wherein the carrier further comprises a receiving frame, the insertion piece set to mount on the receiving frame.

15. The stroller of claim 14, wherein the carrier comprises a bassinet or a child seat for detachably mounting on the receiving frame.

16. A stroller frame for detachably coupling a carrier, comprising:
two side frames; and
two first coupling devices mounted at the outer sides of the respective side frame of the stroller frame and configured to detachably couple to two second coupling devices on the carrier respectively;
wherein the distance between the two side frames is smaller than the distance between the two first coupling devices.

17. The Stroller frame of claim 16, further comprising two linkage devices, each connecting between the first coupling device and the side frame.

18. The stroller frame of claim 17, wherein each side frame comprises a front leg frame and a rear leg frame pivotally connecting to the front leg frame, the first coupling devices are mounted at the outer sides of the respective front leg frames, and each of the linkage devices connects between the first coupling device and the rear leg frame.

19. The Stroller frame of claim 17, wherein each of the linkage devices comprises a first link and a second link, one end of the second link connecting to the first coupling device and the first link pivoting to the side frame and the other end of the second link.
